(19) United States
(12) Patent Application Publication
(10) Pub. No.: US 2003/0101837 A1
(43) Pub. Date: Jun. 5, 2003

(54) Actuator

(76) Inventor: John Abrahamsen, Nordborg (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/240,214

(22) PCT Filed: Mar. 28, 2001
(86) PCT No.: PCT/DK01/00211

(30) Foreign Application Priority Data
Mar. 31, 2000 (DK) PA2000 00534

(51) Int. Cl. F16H 1/16; F16H 37/04

(52) U.S. Cl. 74/425; 74/423; 475/343

(57) ABSTRACT

An actuator with an electric motor which drives an activation element, such as a rotatable arm or a longitudinally movable rod, via a transmission. The transmission has at least two transmission stages, the first one being formed by a worm drive, the second one being formed by a crown and bevel wheel (5; 4a, 4b), the bevel wheel (4a, 4b) being driven by the worm wheel (3a, 3b), and the crown wheel (5) having a power take-off (15). The transmission may readily be formed so that the axis of the crown wheel (5) is in direct extension of the worm (2). A relatively compact transmission with a high gearing may be achieved hereby, and with worm wheel as well as crown and bevel wheel of plastics the transmission is also comparatively noiseless.

The present invention relates to an actuator of the type wherein an electric motor drives an activation element, such as a rotatable arm or a longitudinally movable rod, via a transmission, and wherein the transmission has at least two transmission stages, the first one being formed by a worm drive with a worm and a worm wheel.

Actuators are used inter alia for performing movements and positional adjustments in articles of furniture, including beds and loose mattress supports, sickbeds and hospital beds, nursing equipment, seats for vehicles, machinery and within the industry, etc. Examples of linear actuators may be found in the applicant's EP 647 799 and EP 662 573, both Linak A/S, and DE 38 42 078 Niko Gesellschaft für Antriebstechnik GmbH as well as WO99/16333 Inventions & Developments Holland B.V. An example of a rotary actuator is found in German Utility Model DE 298 02 384 U1 Recticel Internationale Bettsysteme GmbH, which discloses a mattress support with incorporated rotary actuators for adjusting the backrest part and/or the leg-rest part.

The associated electrical equipment is usually a low volt equipment where the actuators are typically driven by a 24V DC motor. The motors available involve the problem that a strong gearing has to take place, as the motors have a relatively high number of revolutions, while the actuator has to move very slowly relatively to this. For example, the motor may have a number of revolutions of the order of 3000 r.p.m., while the actuator performs a full movement in a period of time of the order of 30 sec. or even as slow as 60 sec. Various solutions have been contemplated in order to achieve the high reduction, but these have either been too expensive, too bulky, not sufficiently mechanically stable or too noisy.

The object of the invention is to provide an actuator which allows one or more of these problems to be obviated.

This is achieved according to the invention with an actuator of the type stated in the opening paragraph, wherein the subsequent transmission stage is formed by a crown and bevel wheel, wherein the bevel wheel is driven by the worm wheel, and wherein the crown wheel has a power take-off, said power take-off being arranged in extension of or substantially in extension of the worm or in parallel therewith. This provides an actuator having a relatively compact transmission with a high gearing, and with worm wheel in plastics the actuator is moreover comparatively noiseless. Crown and bevel wheels may be manufactured with simple moulding tools, by plastics moulding with a two-jawed tool, so that basically the manufacturing costs may be kept at a low level.

When the transmission comprises an additional worm wheel and bevel wheel arranged diametrically opposite the first worm and bevel wheel, a balanced distribution of the forces is achieved. The worm and the crown wheel are stabilized, and the force distribution may be used for transferring greater forces or reducing dimensions or alternative selections of materials.

In an embodiment, worm wheel and bevel wheel are formed in one piece, which ensures optimum coupling between these and also facilitates mounting. Worm and bevel wheels of plastics may be made as one member in a two-jawed injection moulding tool.

In a further embodiment the motor housing is provided with a front cover with a mount for the free end of the worm, and the cover is additionally provided with shafts for worm wheel/bevel wheel as well as a shaft for the crown wheel. This has evident advantages in terms of mounting.

When the power take-off of the crown wheel is formed as an axis-parallel toothed wheel, it may readily be used as a sun wheel when built together with a planetary gear. Here, too, it is expedient that crown wheel and toothed wheel are made in one piece.

In an embodiment, the shaft of the crown wheel is provided with a bearing bushing, and also the free end of the worm is expediently mounted in a bearing bushing in the front member.

When constructing worm wheel, bevel wheel and crown wheel, said crown having a toothed wheel as power takeoff, of plastics, the costs may be reduced while keeping the noise at a low level.

The invention will be explained more fully below with reference to the embodiments illustrated in the accompanying drawing. In the drawing:

FIG. 1 is a schematic lateral view of a first embodiment,

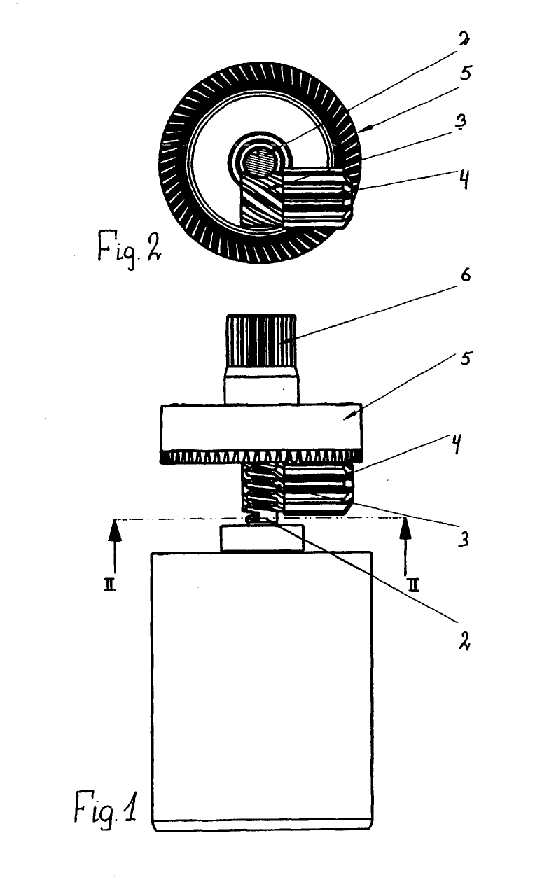

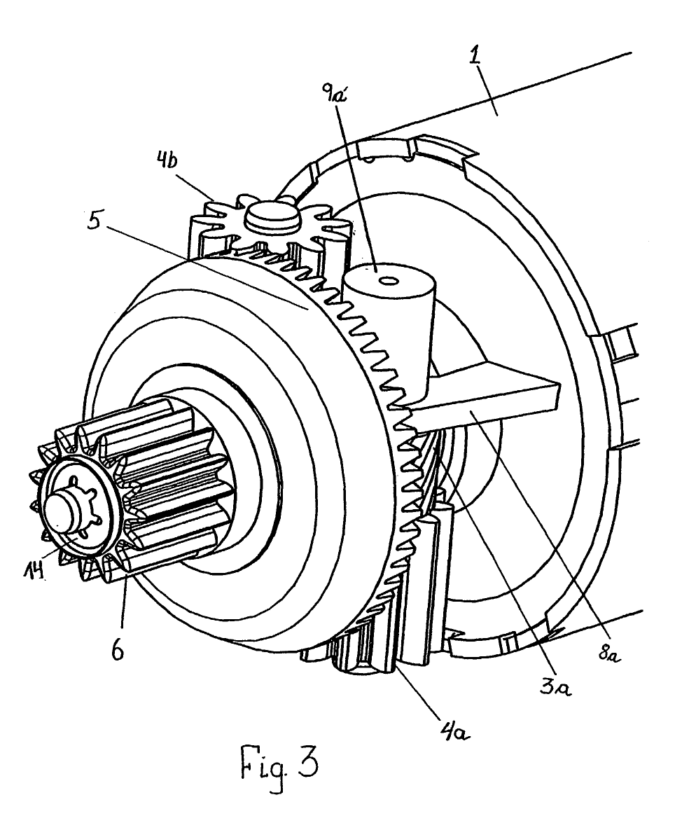

FIG. 2 shows a section along II-II in FIG. 1,

FIG. 3 is a perspective view of a second embodiment, seen from the front,

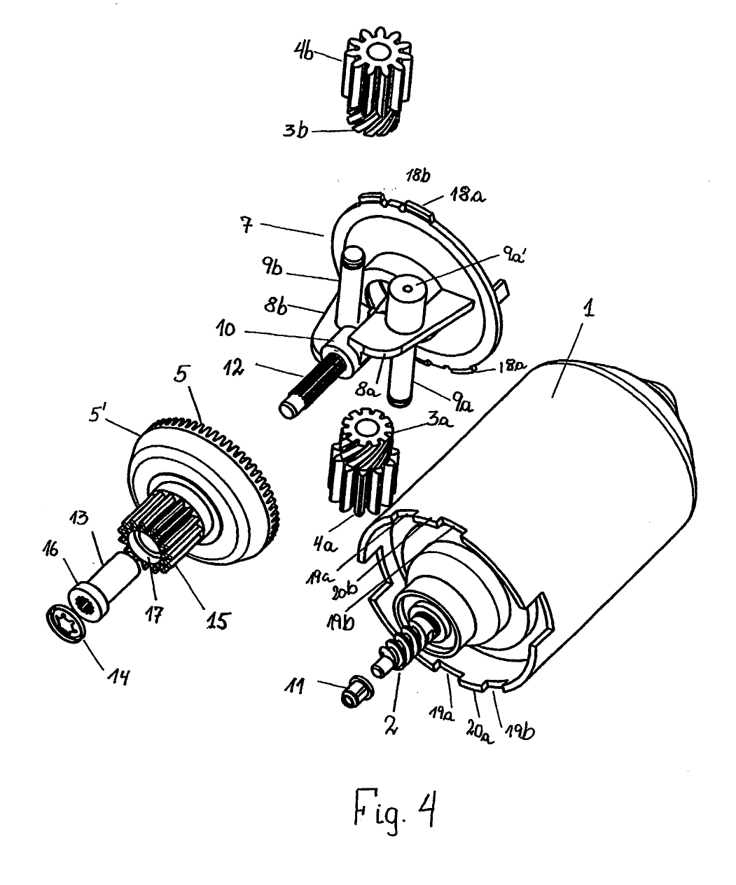

FIG. 4 is an exploded view thereof,

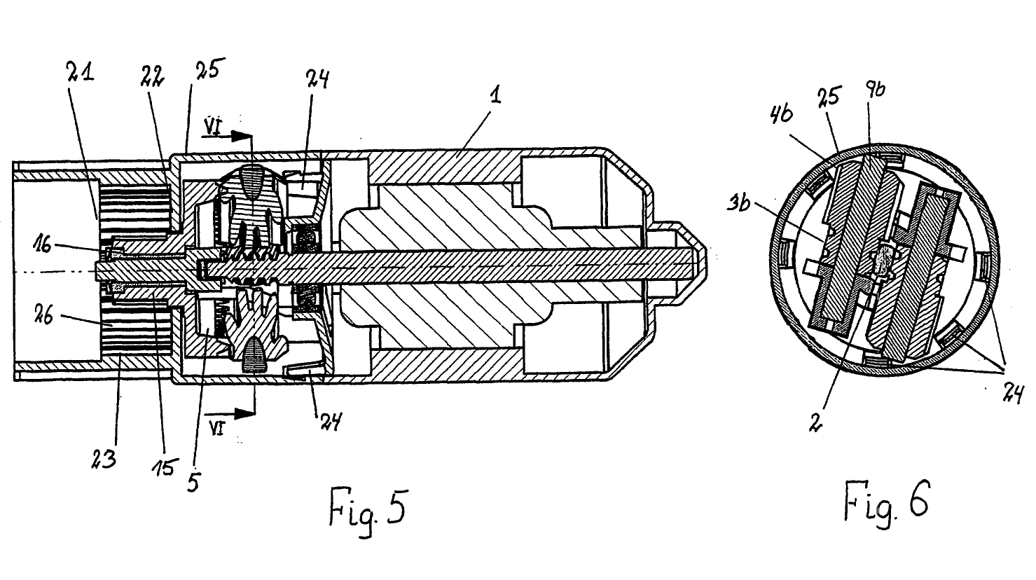

FIG. 5 shows a longitudinal section through an embodiment with a planetary gear, and

FIG. 6 shows a cross-section along VI-VI in the embodiment shown in FIG. 5.

The embodiment illustrated in FIGS. 1 and 2 comprises a 12V or 24V DC motor 1, where a worm 2 is formed in an extended part of the motor shaft. The worm 2, which is of steel, drives a worm wheel 3 and a bevel wheel 4 which as a unit are moulded in plastics. The bevel wheel 4 drives a crown wheel 5 which is likewise of plastics. The crown wheel has a power take-off for connection with the subsequent transmission. Mounting of the unit worm wheel/bevel wheel and crown wheel may be performed in the housing or frame of the actuator, but an attractive way is mounting on the motor, an example being given in the following.

The bevel wheel 4 is cylindrical here, and the same applies to the crown wheel, in the alternative they might be conical. There is a free choice between the common toothings, straight, skew, helical or hypoid, for satisfying specific requirements.

Using the same reference numerals for the same parts, the embodiment shown in FIG. 3 likewise comprises a 12 or 24V DC motor or other form of servomotor 1. In contrast to the foregoing embodiment, there are here two sets of worm and bevel wheels 3a,4a; 3b,4b which are arranged diametrically opposite, with the advantages that the forces are distributed and the load on the toothed wheels is reduced, just as the worm and the crown wheel are prevented from flexing outwards.

As will appear from FIG. 4, the motor housing is here provided with a front cover 7 moulded in lightweight metal. This cover 7 has two forwardly directed brackets 8a, 8b, each with a shaft 9a, 9b, for a worm and bevel wheel 3a,4a; 3b,4b which is secured on the shafts with a locking ring in a groove on the end of the shafts. The shafts 9a, 9b are steel shafts which are secured with the end in a well 9a′ on the brackets intended for the purpose.

Forwardly, the brackets 8a, 8b merge into a cylinder 10 positioned between these. The end of the cylinder facing inwards toward the motor has a hole with an inserted bearing bushing 11, in which the end of the worm 2 is mounted. In addition to being stabilized in the centre by the two worm wheels 3a, 3b, the worm is thus also prevented from flexing by mounting of the end.

A forwardly directed shaft 12, which is arranged in extension of the motor shaft, is provided at the opposite end of the cylinder 10. The shaft 12 is shown here as a loose steel shaft secured in a hole in the cylinder, but the shaft may also be moulded integrally with the cylinder, as indicated in FIG. 5. A bearing bushing 13 is arranged on the shaft 12, secured against rotation by longitudinal grooves and splines, just as the bushing is secured on the shaft by a locking washer 14.

Integrally moulded with the crown wheel 5 is a toothed wheel 15 which forms a sun wheel in a subsequent planetary gear. The sun wheel 15 gives an extra long bearing face for the crown wheel as a whole. The crown wheel 5 is mounted here on the bearing bushing 13 and secured against skidding by a collar 16, which is received in a recess 17 at the end of the sun wheel. The crown wheel may be moulded with a two-jawed tool, where the dividing face is at the root 5′ of the toothing of the crown wheel, and so may worm/bevel wheel, with the parting face being naturally positioned at the dividing line between these.

The front cover 7 is positioned on the motor housing with two sets of flaps 18a, 18b which are received in corresponding incisions 19a, 19b. The flaps 20a, 20b between the two pairs of incisions are used for securing the cover 7, in that the flaps are pressed inwardly over the outer side of the cover, alternatively in that the edge of the motor housing against the flaps 18, 18b is deformed inwardly over these, e.g. with a slotted tool.

FIGS. 5 and 6 show an embodiment with a planetary gear 21 after the crown wheel. The principle is generally as shown in FIGS. 3 and 4, and the same parts have the same reference numerals. The appearance of worm wheel/crown wheel in FIG. 5 is due to the way in which the section is made. The planetary gear is here incorporated in a housing 25, which with one end fits over worm, worm/bevel wheel and crown wheel. The housing includes a transverse wall 22 with a bore for the toothed wheel 15 of the crown wheel, which protrudes into the other end of the housing and meshes with a planetary wheel 26, which in turn meshes with an internal toothing 23 in the housing. The toothed wheel 15 of the crown wheel thus forms a sun wheel in the planetary gear. The housing 25 is secured to the motor housing by snap locking legs 24 formed in the front cover 7. The ends of the snap locking legs 24 engage with mating notches on the inner side of the housing. The planetary gear as a whole may thus be snapped firmly on to the front end of the motor.

As will appear, the structure is compact in the transverse as well as in the longitudinal direction. There is a good and balanced distribution of forces. The crown wheel is firmly mounted and additionally supported by two diametrically positioned bevel wheels. The structure is composed of few parts which are easy to assemble. The gearing is relatively high. The order 1:30 may be given by way of example, distributed equally between worm/worm wheel and bevel wheel/crown wheel. In addition, the transmission has a low level of noise. Finally, the advantage of in-line gearing should be mentioned, i.e. with the drive shaft in extension of the motor shaft.

1. An actuator of the type wherein an electric motor (1) drives an activation element, such as a rotatable arm or a longitudinally movable piston rod, via a transmission, and wherein the transmission has at least two transmission stages, the first one being formed by a worm drive with a worm (2) and a worm wheel (3), characterized in that the subsequent transmission stage is formed by a crown and bevel wheel (5, 4), wherein the bevel wheel (4) is driven by the worm wheel (3), and wherein the crown wheel has a power take-off (6, 15), said power take-off being arranged in extension of or substantially in extension of the worm (2) or in parallel therewith.

2. An actuator according to claim 1, characterized in that the transmission comprises an additional worm wheel (3b) and bevel wheel (4b) arranged diametrically opposite the first worm and bevel wheel (3a, 4a).

3. An actuator according to claim 1 or 2, characterized in that worm wheel and bevel wheel (3,4; 3a,4a; 3b,4b) are formed in one piece.

4. An actuator according to claim 1, characterized in that the motor housing forms a front cover (7) with shafts (9a, 9b) for worm wheel, bevel wheel (3a,4a; 3b,4b) and a shaft (12) for the crown wheel (5).

5. An actuator according to claim 1, characterized in that the power take-off of the crown wheel (5) is formed as an axis-parallel toothed wheel (15).

6. An actuator according to claim 5, characterized in that crown wheel and toothed wheel (5, 15) are formed in one piece.

7. An actuator according to claim 4, characterized in that the shaft (12) of the crown wheel (5) is provided with a bearing bushing (13).

8. An actuator according to claim 4, characterized in that the free end of the worm (2) is mounted in a bearing bushing (11) in the front cover (7).

9. An actuator according to claim 5, characterized in that the transmission additionally comprises a planetary gear (21) in which the sun wheel is formed by the axis-parallel toothed wheel (15) on the crown wheel (5).

10. An actuator according to any one of the preceding claims, characterized in that worm wheel, bevel wheel and crown wheel with a power take-off in the form of a toothed wheel are of plastics.
